(19) United States
(12) Patent Application Publication
(10) Pub. No.: US 2017/0020101 A1
(43) Pub. Date: Jan. 26, 2017

(54) Hands-Free Apparatus for Carrying Small Service Dogs, Emotional Support Animals, and Small Pets

(71) Applicants: Thomas Grey Parker, Los Angeles, CA (US); Ann Elizabeth Henson, Argyle, TX (US)

(72) Inventors: Thomas Grey Parker, Los Angeles, CA (US); Ann Elizabeth Henson, Argyle, TX (US)

(21) Appl. No.: 15/216,715

(22) Filed: Jul. 22, 2016

Related U.S. Application Data
(60) Provisional application No. 62/196,789, filed on Jul. 24, 2015.

(51) Int. Cl. A01K 1/02; A45F 3/02; A44B 11/04; A01K 1/035

(52) U.S. Cl. CPC A01K 1/029; A01K 1/0353; A45F 3/02; A44B 11/04

(57) ABSTRACT

The embodiments of the invention include an ergonomic, hands-free apparatus for carrying service animals, emotional support animals, other animals, groceries and/or other objects. The apparatus includes a pouch configured to accommodate the animal, the pouch being designed to fit securely against a user's body, while still allowing ample room for the animal to be comfortably carried for long periods of time; a wide, flat strap extending from the pouch, the strap configured to be positioned over one of the user's shoulders in a cross-body fashion; a custom, self-contained buckle system that adjusts in length to fit different body types without any dangling straps; a beverage holder, a smart-phone/ID card holder; and a plurality of storage pockets positioned on an outer surface of the pouch, the plurality of storage pockets configured to accommodate personal items and animal supplies.

This application claims the benefit of U.S. Provisional Application No. 62/196,789, filed Jul. 24, 2015.

### BACKGROUND

The embodiments described herein relate generally to accessories for small (under 20 pounds) service animals, and more particularly, to an all-purpose, ergonomic, and hands-free apparatus for carrying small (under 20 pounds) service dogs, emotional support animals, and pets.

Although all public businesses (except hospitals) are legally required to allow service dogs, not all individuals are aware that there are service dogs other than larger seeing-eye dogs on a short leash. Consequently, the presence of a smaller (under 20 pounds) service dog, especially one being carried, may be distracting and/or disruptive. People who specifically require a smaller service dog or emotional support animal to be with them at all times often sacrifice the use of one or both hands in order to carry the animal, the animal's carrier, and/or hold onto the animal's leash. Additionally, the person must keep up with supplies for the animal, along with their own personal items, which conventionally requires an additional purse or bag, making it difficult to be away from home for long periods of time.

Conventional backpack-style carriers tend to be relatively ergonomic, but access to the animal is difficult, restricting the tasks the service animal is trained to perform in order to keep the user safe. Conventional purse-style carriers provide easy access, but tend to interfere with the user's movement, often requiring one or both hands to prevent the carrier from swinging precariously when the user is active, bends over, or extends to reach for an item. Moreover, the narrow shoulder straps and one-sided weight distribution may cause neck and/or shoulder fatigue, especially when worn for extended periods of time, as is common with both service dogs and support animals. Conventional travel-style carriers often have a longer, cross-body, padded shoulder straps, but they are designed specifically for travel (e.g., airplane, car, bus). Not only are they bulky like luggage, which can be difficult to manage in tight spaces, but they often draw unwanted attention to the person's disabilities. More importantly, these carriers are designed to restrain the animal, hindering a service dog from the performing tasks it's been trained to do in order to keep the owner safe. Specifically, none of these conventional animal carriers are designed with the unique requirements of a small service dog or emotional support animal, in mind.

Therefore, what is needed is an all-purpose, ergonomic, and hands-free apparatus designed for carrying small (under 20 pounds) service dogs and emotional support animals, wherein the apparatus is adjustable, modular, and can accommodate important items other than just the animal, all while causing limited arm, shoulder, or back fatigue.

### SUMMARY

Some embodiments of the invention include an ergonomic, hands-free apparatus for carrying a small (under 20 pounds) service dog or emotional support animal, along with important animal care and personal items. The apparatus may include a main pouch configured to accommodate the animal, the apparatus being designed to fit securely against a user's body; a strap extending from the pouch, the strap configured to be positioned over one of the user's shoulders in a cross-body fashion; a custom designed buckle system that does not poke or rub against the person's body, wide enough to accommodate a 4-inch strap, and enables the same apparatus to be comfortably worn by most body types (petite to XXL). This specialized buckle system also creates a self-contained strap with no annoying loose dangling strap ends. The front of the apparatus may comprise a beverage holder, a smartphone/identification card holder, and a plurality of storage pockets positioned on the outer surface of the pouch, configured to accommodate important service animal supplies and personal items.

### BRIEF DESCRIPTION OF THE FIGURES

Having thus described the invention in general terms, reference is now made to the accompanying figures, which show different views of different example embodiments. Such description makes reference to the drawings wherein:

FIG. 1 is a front and back view of the example embodiment illustrated in place on a user.

FIG. 2 is a front and three back views of one embodiment that may be worn on the right shoulder.

FIG. 3 is a front and three back views of one embodiment that may be worn on the left shoulder.

FIG. 4 is a front and three back views of one embodiment that may be worn on both shoulders.

FIG. 5 is a front and side view illustration of the single loop buckle with teeth and double loop slide buckle used in an embodiment of the apparatus.

FIG. 6 shows how the single loop buckle with teeth and double loop slide buckle are positioned on the strap.

FIG. 7 illustrates an embodiment of the apparatus when converted into a portable dog bed.

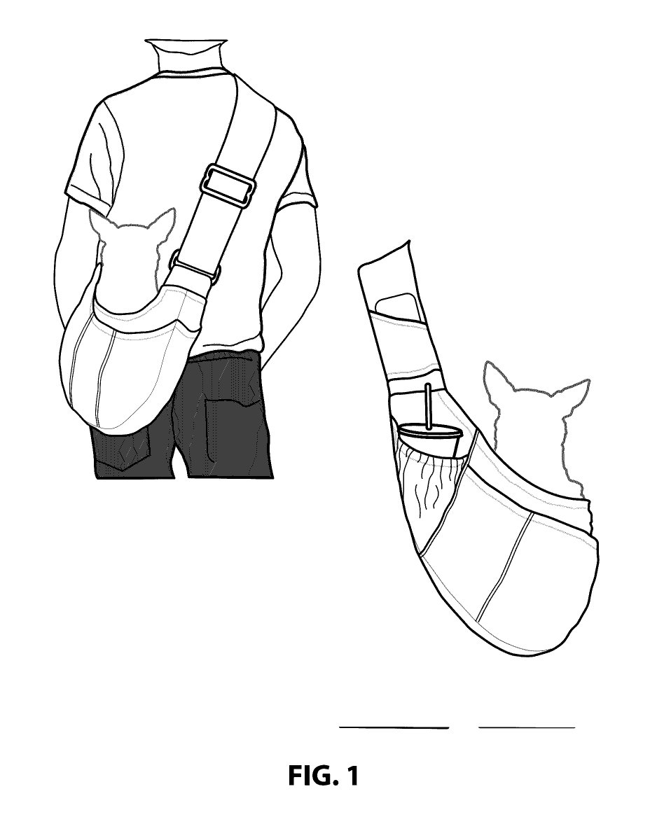

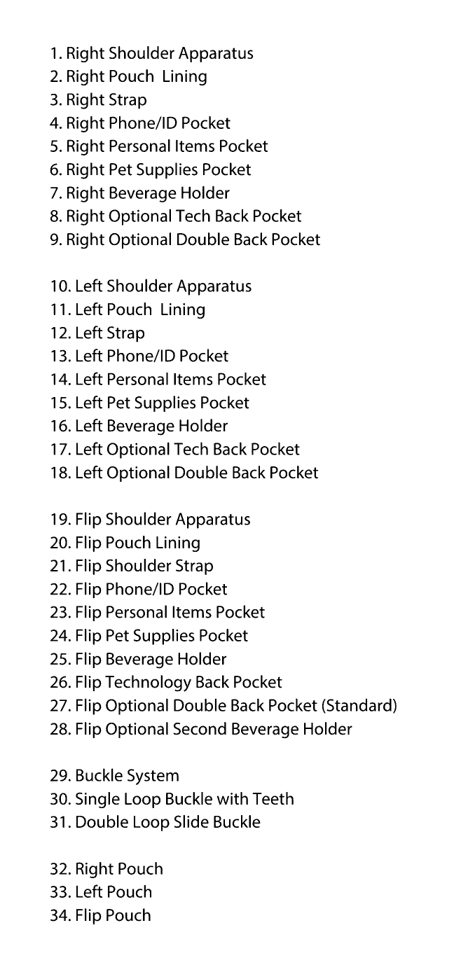

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The apparatus of the present disclosure may be used to carry a small (under 20 pounds) service dog, emotional support animal, or pet, along with important service animal supplies and personal items and may be comprised of the following elements. This list of possible constituent elements is intended to be exemplary only, and it is not intended that this list be used to limit the apparatus of the present application to just these elements. Persons having ordinary skill in the art relevant to the present disclosure may understand there to be equivalent elements that may be substituted within the present disclosure without changing the essential function or operation of the device.
1. Cross-Body Style Apparatus
2. Custom (Extra Wide) Strap Buckle System
3. Beverage Holder
4. Smartphone/Identification Badge Holder
5. Storage Pockets

The various elements of the apparatus 1, 10, 19 of the present invention may be related in the following exemplary fashion. It is not intended to limit the scope or nature of the relationships between the various elements and the following examples are presented as illustrative examples only.

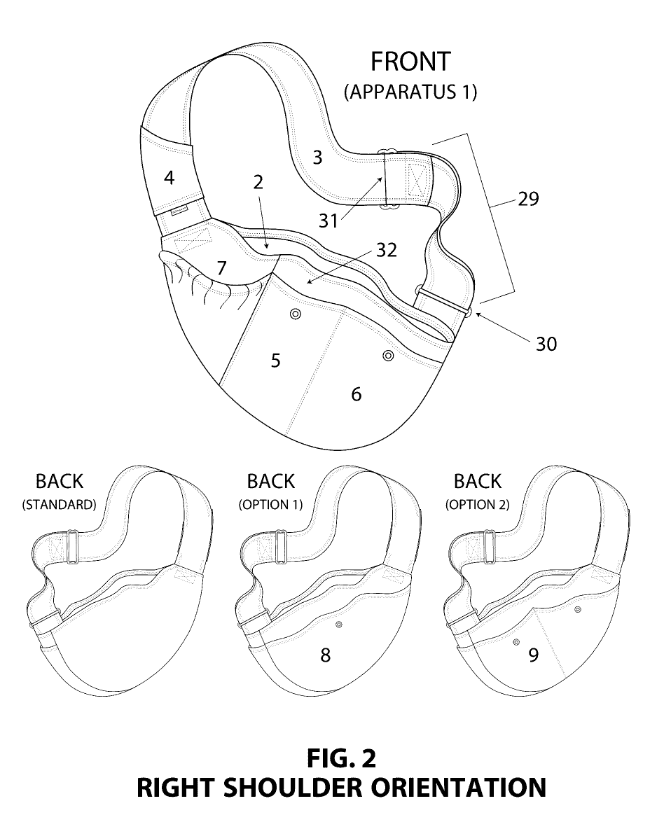

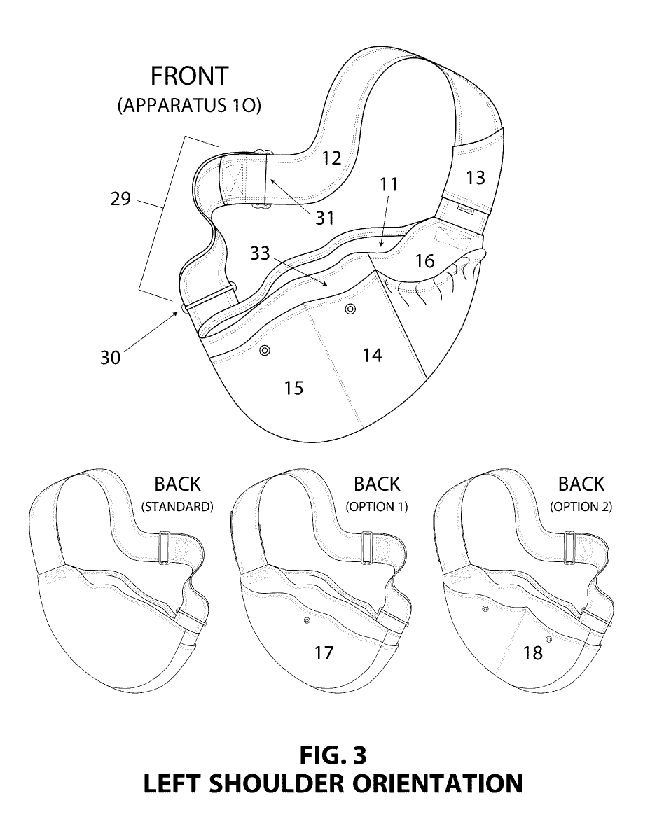

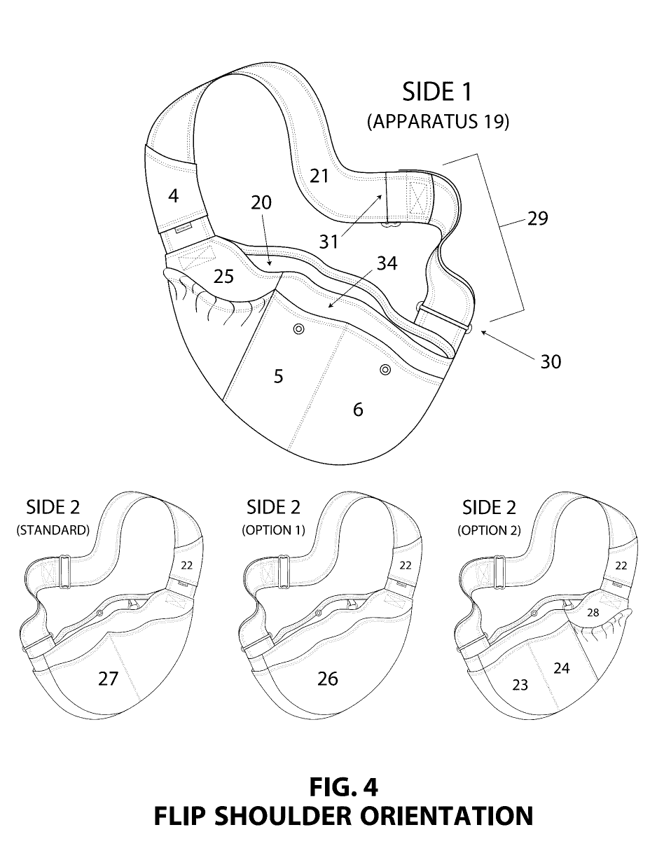

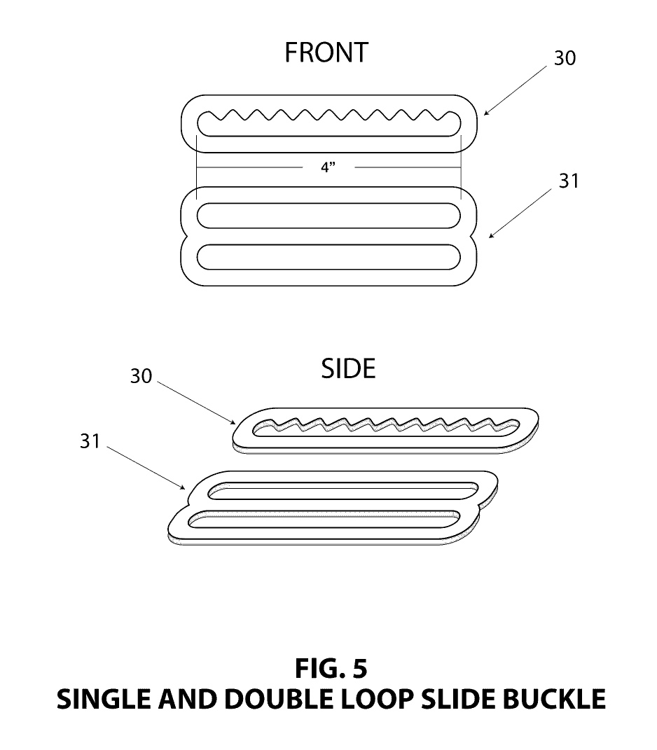

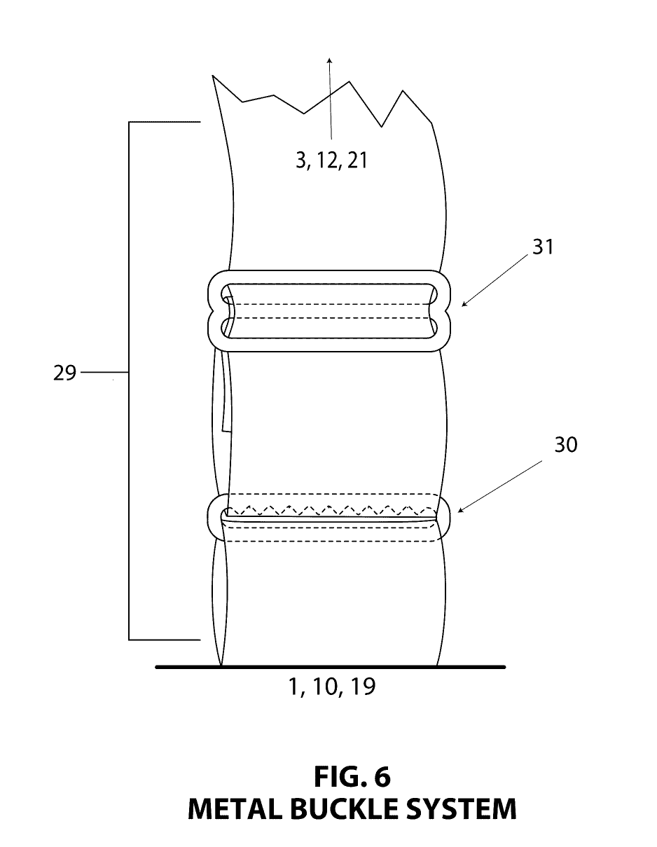

By way of example, and referring to the figures, some embodiments of the invention include a cross-body style apparatus 1, 10, 19 configured to accommodate a small (under 20 pounds) service dog, emotional support animal, or pet, and important service animal supplies and personal items. As shown in FIG. 2, the cross-body style apparatus 1 may comprise a right pouch 32 having a right strap 3 configured to be worn over a user's right shoulder. As shown in FIG. 3, cross-body style apparatus 10 may comprise a left pouch 33 having a left strap 12 configured to be worn over a user's left shoulder. As shown in FIG. 4, the cross-body style apparatus 19 may comprise a flip pouch 34 having a reversible strap 21 configured to be worn over either shoulder. In any instance, the apparatus 1, 10, 19 may have an ergonomic, sleek shape that allows it to be worn over or under a jacket or coat, enabling the user to be discrete as well as maneuver in tight spaces. In these embodiments, the apparatus 1, 10, 19 comprises a specially designed, self-contained buckle system 29, 30, 31 that provides for adjustability of the fit of the apparatus 1, 10, 19 to accommodate substantially any sized individual with no uncomfortable poking or rubbing against the person's body, and no cumbersome dangling strap ends.

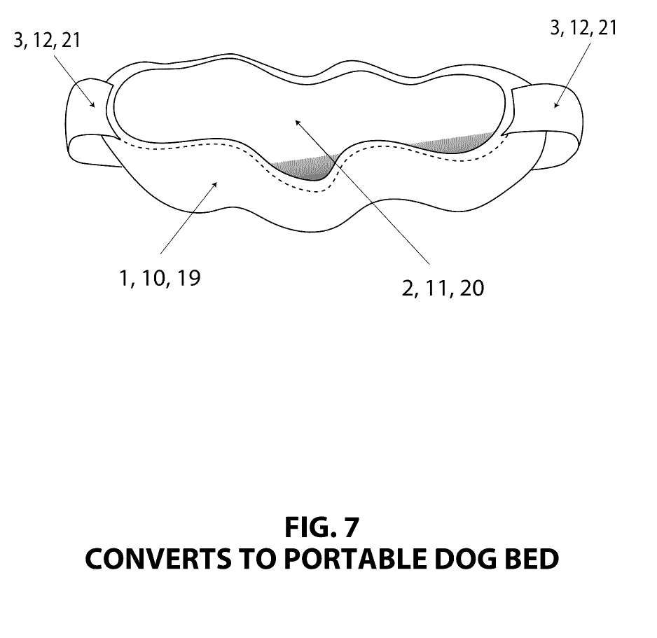

The pouch 32, 33, 34 may comprise an interior configured to comfortably accommodate a small (under 20 pounds) animal, wherein the interior walls that define the interior may comprise a lining 2, 11, 20. While the apparatus 1, 10, 19 is comfortable both standing and sitting, when removed and turned inside out, the apparatus 1, 10, 19 doubles as a portable dog bed, as shown if FIG. 7, providing a barrier between the dog and upholstery, or the dog and the ground.

The apparatus 1, 10, 19 may comprise a custom, extra-wide (4 ½-inch) aluminum, “slide and loop” buckle 30, 31 designed to accommodate the 4-inch wide shoulder strap 3, 12, 21 required to reduce arm, neck, and shoulder fatigue. The embodiment may include a custom single loop buckle with teeth 30 which enable lighter and softer fabrics to be used, reducing the bulk and weight of the overall apparatus 1, 10, 19 without jeopardizing stability and strength. The embodiment may comprise a custom double loop slide buckle 30 to be slid forward or backward along the length of the strap 3, 12, 21 to adjust the overall length of the strap 3, 12, 21. In some embodiments, the strap 3, 12, 21 may be adjusted from a length of 28 inches to a length of 42 inches, although other lengths are envisioned, resulting in a strap 3, 12, 21 that does not poke or rub against the person's body, and enables the same apparatus 1, 10, 19 to be worn by body types (petite to XXL). This buckle system 29, 30, 31 also creates a self-contained strap 3, 12, 21 with no annoying loose dangling strap ends.

The front surface of the apparatus 1, 10, 19, wherein the front surface is the surface opposite a user, may comprise of a beverage holder 7, 16, 25, wherein the beverage holder 7, 16, 25 is configured to accommodate a small or large cup, or other beverage container (e.g., water bottle) therein. Because of the unique shape and design of the apparatus 1, 10, 19 and the beverage holder 7, 16, 25, a beverage stored therein may not spill, even when a user bends over or otherwise moves. Moreover, in some embodiments, the beverage holder 7, 16, 25 may comprise an insulated material to aid in keeping a beverage stored therein cold or hot. In some embodiments (i.e., Flip Shoulder Apparatus), the apparatus 19 may comprise a second beverage holder 28.

The strap 3, 12, 21 may comprise a smartphone and/or identification storage pocket 4, 13, 22 attached thereto, wherein the phone/ID storage pocket 4, 13, 22 configured to accommodate a user's phone, identification card or other “quick access” personal items.

The outer surface of pouch 32, 33, 34 may comprise a plurality of storage pockets, each designed to meet the special needs of both the service animal and the person. This outer surface may comprise a personal items storage pocket 5, 14, 23 configured to accommodate user's personal items (e.g., wallet, keys), and an animal supply storage pocket 6, 15, 24 configured to accommodate the important service animal supplies (e.g., identification and medical badges, collapsible water/food bowl, vests and leash, waste disposal bags and the like).

A back surface of the pouch 32, 33 34 may also include additional storage pockets. For example, the back surface may comprise a technology pocket 8, 17, 26 configured to accommodate a user's tablet or other larger personal items. Alternatively, the back surface may comprise a double pocket configuration 9, 18, 27 configured to accommodate personal items. In yet a further embodiment, the back surface may not comprise any storage pockets, leaving a smooth back surface to be positioned against a user's body.

The apparatus 1, 10, 19 of the present disclosure may be made of any suitable material and may be of any desired size. The elements of the apparatus 1, 10, 19 may be reversed and/or shuffled to accommodate the user's special needs and preferences. Moreover, the pouch 32, 33, 34 may be altered to accommodate less common animal species and sizes.

The apparatus 1, 10, 19 may be worn in a cross-body fashion, wherein the strap 3, 12, 21 is positioned over one of the user's shoulders. The service dog/emotional support animal, personal items, and animal supplies may be placed into the desired phone/identification pocket 4, 13, 22, beverage holder 7, 16, 25, and animal/personal supply pockets 5, 6, 14, 15, 23, 24 and the user may go about his or her day.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. For example, while the apparatus 1, 10, 19 is created to support the owner of a small (under 20 pounds) service dog or emotional support animal, the unique features of the apparatus 1, 10, 19 may be useful for any small animal, groceries and/or other objects. Thus, one of ordinary skill in the art would understand that the invention is not to be limited by the foregoing illustrative details, but rather is to be defined by the appended claims.

What is claimed is:

1. An ergonomic, hands-free apparatus for carrying service animals, emotional support animals, other animals, groceries and/or other objects, the apparatus comprising:
a pouch configured to accommodate the animal or object, the pouch being designed to fit securely against a user's body; and
a strap extending from the pouch, the strap configured to be positioned over one of the user's shoulders in a cross-body fashion; and
a buckle system for adjusting a length of the strap; and
a plurality of storage pockets to accommodate personal items and animal supplies.

2. An ergonomic, hands-free apparatus for carrying service animals, emotional support animals, other animals, groceries and/or other objects, the apparatus comprising:
a pouch configured to accommodate the animal or object, the pouch being designed to fit securely against a user's body; and
a strap extending from the pouch, the strap configured to be position over one of the user's shoulders in a cross-body fashion.

3. An apparatus as in claim 2, wherein the pouch and strap are configured to be positioned over the user's right shoulder in a cross-body fashion.

4. An apparatus as in claim 2, wherein the pouch and strap are configured to be positioned over the user's left shoulder in a cross-body fashion.

5. An apparatus as in claim 2, wherein the pouch and strap are configured to be positioned to be switch between both the user's right and left shoulder in a cross-body fashion.

6. An apparatus as in any one of claims 3-5, further comprising a self-contained buckle system with no dangling strap ends for adjusting a length of the strap.

7. An apparatus as in any one of claims 3-6, further comprising a beverage holder.

8. An apparatus as in any one of claims 3-7, further comprising a phone/identification pocket.

9. An apparatus as in any one of claims 3-8, further comprising tech pocket.

10. An apparatus as in any one of claims 3-9, further comprising a plurality of storage pockets.
